(19) United States
(12) Patent Application Publication
(10) Pub. No.: US 2017/0126586 A1
(43) Pub. Date: May 4, 2017

(54) METHOD AND DEVICE FOR EQUIPMENT CONTROL

(71) Applicant: Xiaomi Inc., Beijing (CN)

(72) Inventors: Yong Chen, Beijing (CN); Yincheng Xu, Beijing (CN); Guizhen Yang, Beijing (CN); Weiyang Chen, Beijing (CN)

(73) Assignee: Xiaomi Inc., Beijing (CN)

(21) Appl. No.: 15/203,385

(22) Filed: Jul. 6, 2016

(30) Foreign Application Priority Data
Oct. 30, 2015 (CN) 201510728203.7

(51) Int. Cl. H04L 12/927; H04L 29/08

(52) U.S. Cl. CPC H04L 47/803; H04L 67/02; H04L 67/327

(57) ABSTRACT

A network control system for controlling a visitor network and a network access security protocol for allowing client devices from accessing the visitor network is provided. The network control system relies on a combination of information retrieved from the client device requesting access to the visitor network and information retrieved from network components that make up the network control system to implement the network access security protocol in an efficient manner that minimizes the need for a user to input a password to access the visitor network.

### CROSS-REFERENCE TO RELATED APPLICATIONS

This application claims priority to Chinese Patent Application 201510728203.7, filed on Oct. 30, 2015, the entirety of which is hereby incorporated by reference herein.

### TECHNICAL FIELD

The present disclosure generally relates to the technical field of computers, and more particularly, to systems, methods, and apparatuses for controlling network access.

### BACKGROUND

When a Wi-Fi network is created, a user may configure the Wi-Fi network to be accessible by a password. Requiring a communication device to provide the password to access the Wi-Fi network provides a security measure for the Wi-Fi network, such that a visitor operating the communication device is permitted access to the Wi-Fi network after successfully providing the password.

### SUMMARY

According to some embodiments, a method for controlling a network control system to operate a network access security protocol is provided. The method may include receiving a first Identifier (ID) corresponding to a client device requesting access to the network, a visitor account corresponding to a client application running on the client device, and a second ID corresponding to a component of the network control system. The client application running on the client device may control the client device to transmit the first ID, the visitor account, and the second ID to be received by the network control system. The method may further include acquiring a manager account associated with the second ID. When it is determined that a predetermined relationship is satisfied between the visitor account and the manager account, the method may further include determining, by the network control system, to grant the client device access to the network, where the client device is identified according to the first ID.

According to some embodiments, a method for controlling a network control system to operate a network access security protocol is provided. The method may include acquiring a first Identifier (ID) corresponding to a client device requesting access to the network, a visitor account corresponding to a client application running on the client device, and a second ID corresponding to a component of the network control system. The method may further include transmitting the first ID, the second ID and the visitor account to the network control system. The client application running on the client device may control the client device to transmit the first ID, the visitor account, and the second ID, to the network control system. The network control system may include a memory for storing a list of predetermined usage permissions that identify client devices, client applications, and/or client application users that have usage permissions to access the network. The method may further include acquiring a manager account associated with the second ID and determining that the client device is identified as having the predetermined usage permission according to the first ID when it is determined that a predetermined relationship is satisfied between the visitor account and the manager account.

According to some embodiments, a network control system is provided. The network control system may include a receiver interface configured to receive, from a client device, a first ID, a visitor account associated with a client device, and a second ID corresponding to a network component of the network control system. The network control system may further include an acquisition interface configured to acquire a manager account associated with the second ID. The network control system may further include a controller configured to, when it is determined that a predetermined relationship is satisfied between the visitor account and the manager account, determine that the client has a predetermined usage permission according to the first ID.

According to some embodiments, a network control system is provided for communicating with a client device. The network control system may include a router configured to acquire, from the client device, a first ID of the client device, a visitor account corresponding to the client device, and a second ID corresponding to a network component of the network control system. The router may further be configured to transmit the first ID, the second ID, and the visitor account to a server. The network control system may further include the server, where the server may be configured to determine that the client device has a predetermined usage permission. The server may be configured to acquire a manager account associated with the second ID and determine that the client device has the predetermined usage permission according to the first ID when it is determined that a predetermined relationship is satisfied between the visitor account and the manager account.

According to some embodiments of the present disclosure, a network control system for operating a network access security protocol for a corresponding network is provided. The network control system may include a processor and a memory configured to store instructions executable by the processor. The processor may be configured to execute the instructions to receive a first ID corresponding to a client device, a visitor account associated with a client application running on the client device, and a second ID corresponding to a network component of the network control system. The processor may be further configured to acquire a manager account associated with the second ID. And when it is determined that a predetermined relationship is satisfied between the visitor account and the manager account, the processor may be further configured to determine that the client device is granted a predetermined usage permission according to the first ID.

According to some embodiments, a device for controlling network access by a client device is provided. The device may include a processor and a memory configured to store instructions executable by the processor. The processor may execute the instructions to acquire a first ID corresponding to the client device and a second ID corresponding to a network component of a network control system. The processor may further be configured to execute the instructions to transmit the first ID, the second ID and a visitor account corresponding to the client device to the network component. The processor may further be configured to execute the instructions to determine a predetermined usage permission for the client device, and acquire a manager account associated with the second ID and determine that the client device is granted the predetermined usage permission according to the first ID when it is determined that a predetermined relationship is satisfied between the visitor account and the manager account.

It is to be understood that the above general description and detailed description below are only exemplary and explanatory and not intended to limit the embodiments of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 shows an exemplary flow chart of logic that a network control system may implement for determining whether to allow a requesting client device access to a network controlled by the network control system, according to an exemplary embodiment.

FIG. 2 shows an exemplary flow chart of logic that a device within a network control system may implement for determining whether to allow a requesting client device access to a network controlled by the network control system, according to another exemplary embodiment.

FIG. 3A shows an exemplary flow chart of logic that a network control system may implement for determining whether to allow a requesting client device access to a network controlled by the network control system, according to another exemplary embodiment.

FIG. 3B shows an exemplary system interaction block diagram that includes logic that a network control system may implement for determining whether to allow a requesting client device access to a network controlled by the network control system, according to an exemplary embodiment.

FIG. 4 shows a structure for implementing a logic that an exemplary network control system may implement, according to an exemplary embodiment.

FIG. 5 shows a structure for implementing a logic that an exemplary network control system may implement, according to an exemplary embodiment.

FIG. 6 shows a structure for implementing a logic that an exemplary device may implement, according to an exemplary embodiment.

FIG. 7 shows a structure for implementing a logic that an exemplary device may implement, according to an exemplary embodiment.

FIG. 8 is a block diagram of an exemplary network component device, according to an exemplary embodiment.

FIG. 9 is a block diagram of an exemplary network component device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

Given the increasing level of connectivity between users of communication devices through communication networks, determining how to allow access to the communication networks that allow for the connectivity is a feature that network architects consider. For some networks, an open security protocol that allows all communication devices that are able to connect to the network effective access to the network without any additional security measures may be applicable for the particular application. For other networks, it may be recognized that a security protocol may be preferable to enforce that restricts which communication devices may gain access to the network. The security protocol may include a feature that calls for a communication device requesting access to the network (e.g., client device) to provide some type of authentication information to a network control system responsible for implementing the security protocol of the network. The security protocol may then include a feature that calls for the network control system to analyze the received authentication information and make a determination on whether to allow access to the communication device based on the analysis of the received authentication information.

The network described herein may include a wired, or wireless, network configured to couple a communication device with other client devices coupled to the network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G; 3G or 4G) cellular technology, or the like. Network access technologies may enable wide area coverage for devices, such as client devices with varying degrees of mobility, for example. For example, the network described herein may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within the network, or the like.

Unlike other network security protocols, the network security protocols described in this disclosure may not be reliant on a user input password or other type of user dependent authentication information being exchanged with the network control system to gain access to a network and may be implemented to offer a self-sufficient solution for granting access to the network. The network security protocols may be self-sufficient by referencing previous authentication information enacted on the communication device, and communicating the previous authentication information to the network control system as authentication information for accessing the network. Further description is provided below of the various types of previous authentication information that may be referenced as authentication information for automatically accessing a network according to different embodiments.

The client device referenced throughout this disclosure may be a communication device that includes well known computing systems, environments, and/or configurations suitable for implementing features of the network security protocol described herein such as, but are not limited to, smart phones, tablet computers, personal computers (PCs), server computers, handheld or laptop devices, multiprocessor systems, microprocessor-based systems, network PCs, server computers, minicomputers, mainframe computers, embedded systems, distributed computing environments that include any of the above systems or devices, and the like.

The network control system referenced throughout this disclosure may include one or more network component devices that includes well known computing systems, environments, and/or configurations suitable for implementing features of the network security protocol described herein such as, but are not limited to, smart phones, tablet computers, personal computers (PCs), server computers, routers, databases, handheld or laptop devices, multiprocessor systems, microprocessor-based systems, network PCs, server computers, minicomputers, mainframe computers, embedded systems, distributed computing environments that include any of the above systems or devices, and the like.

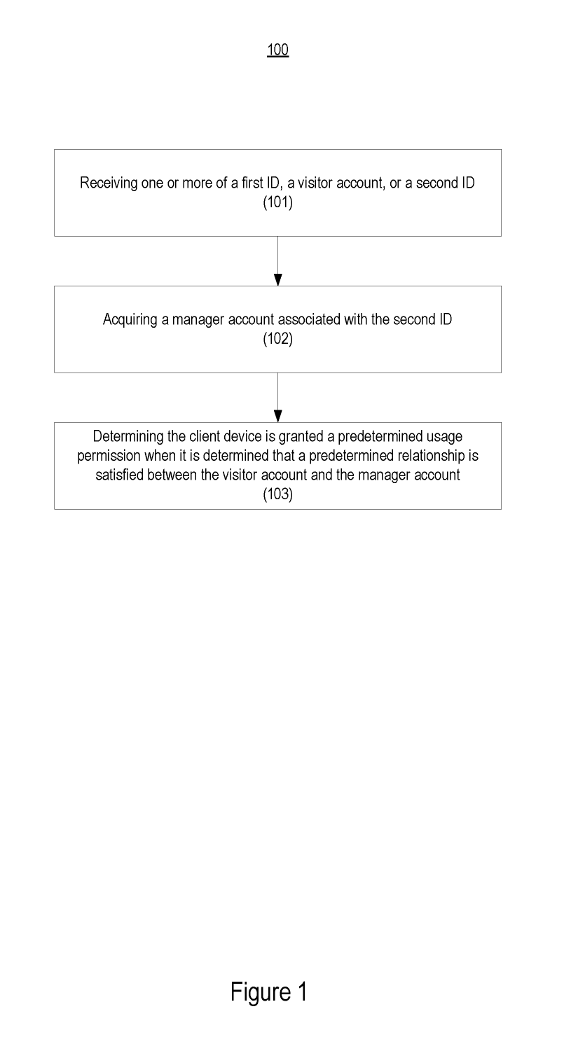

FIG. 1 shows an exemplary flow chart 100 of logic that a network control system may implement for determining whether to allow a requesting client device access to a corresponding network controlled by the network control system. The flow chart 100 references the client device, where the client device may be identifiable by a first ID, stored within a memory of the client device. The client device may be running a client application. The client device may further store visitor account information that identifies the client application running on the client device, and/or identifies a user or user account of the client application running on the client device. The visitor account information may include, for example, username, QQ ID or number that relates to a social networking platform, WeChat ID or number, MiTalk ID or number, passwords, nicknames, related mobile phone numbers, signature information, or other information corresponding to the user. One of the features implemented by the client application may include communicating with the network control system to receive component information for one or more network components included in the network control system. The network components may include, for example, a router and/or a server that are part of the network control system. The component information may include second ID information for identifying a network component that is part of the network control system.

When the client device comes within connection range of the network, the client device may control an interface of the client device to transmit a network access request that includes one or more of the first ID, visitor account information, or the second ID. It follows that the network control system may receive the network access request from the client device that includes the one or more of the first ID, visitor account information, and the second ID (101).

After receiving the network access request, the network control system may acquire manager account information corresponding to the second ID (102). For example, the network control system may parse a database of manager account information to identify and acquire the manager account information corresponding to the second ID. The manager account information may correspond to the same, or different, user that correspond to the visitor account information, where the manager is a special designation for the user within the client application environment. For example, the first ID may be a unique ID for a visiting device. The visitor account ID may be the WeChat ID of the user/visitor. The second ID of the control system may be the unique ID of the router. The manager's ID may be their own WeChat ID.

The network control system may compare the visitor account information to the manager account to determine whether the manager account identifies a predetermined relationship with the visitor account information. The predetermined relationship may be set up to identify a “friend” relationship, a “relative” relationship, or other identifiable relationship between users that correspond to the visitor account information and the manager account information. When the network control system determines that the predetermined relationship is satisfied between the visitor account information and the manager account, the client device may be granted access to the network according to the client device's first ID identification (103). The access granted to the client device may be a predetermined usage permission level assigned to the client device according to the client device's first ID.

By implementing the security protocol described by flow chart 100, the network control system may provide selective access to the network based on a determination that a predetermined relationship is satisfied between the visitor account information received from the client device requesting network access and manager account information stored within the network control system. Based on a confirmation that the predetermined usage permission level has been satisfied, the client device, as identified by the first ID, may be allowed access to the network. The access allowed to the client device may be in accordance to a predetermined usage permission level assigned to the client device's first ID, and as identified in the manager account.

The security protocol described by flow chart 100 allows the network control system to verify an identity of the client device, client application, and/or client application user, requesting access to network based on a relationship between the visitor account information (e.g., the visitor account information verifies the client device and/or client application user has successfully logged into the client application and/or client device) and the manager account (e.g., the manager account includes a list of client devices, client applications, and/or client application users that are known to have been granted access to the network) rather than verifying the identity of the client device, client application, or client application user, according to a password. Therefore, the solution described by flow chart 100 frees a user from being required to manually input a password to gain access to the network, which promotes the efficiency of saving the user operation time.

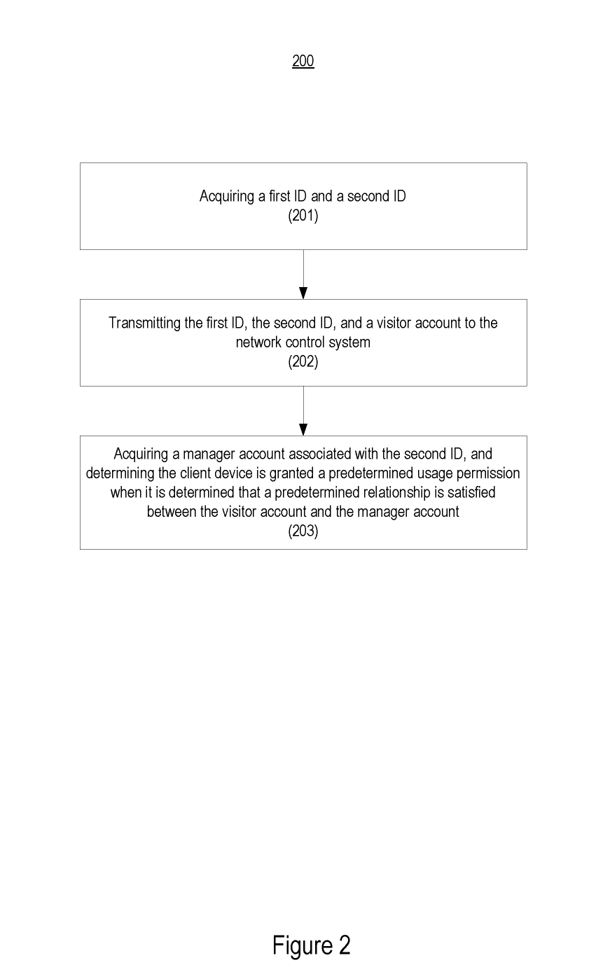

FIG. 2 shows an exemplary flow chart 200 of logic that a network component device (e.g., a router device included in a network control system) may implement for determining whether to allow a requesting client device access to a corresponding network controlled by the network control system. The flow chart 200 references the client device, where the client device may be identifiable by a first ID, stored within a memory of the client device. The client device may be running a client application. The client device may further store visitor account information that identifies the client application running on the client device, and/or identifies a user or user account of the client application running on the client device. One of the features implemented by the client application may include communicating with different network component devices included in the network control system to transmit and receive component information for one or more network component devices included in the network control system. The network component devices may include, for example, routers and/or servers that are part of the network control system. The component information may include second ID information for identifying a corresponding network component device that is part of the network control system.

When the client device comes within connection range of the network, the client may acquire the first ID and the second ID according to any of the methods described herein (201).

Having acquired the first ID and the second ID, the client application may control the client device to transmit the first ID, second ID, and the visitor account information to the network component device (202). For example, the client device may control transmission of the first ID, second ID, and the visitor account information base on the second ID that may identify the network component device.

The network component device, or another network component device within the network control system that is in communication with the network component device, may acquire a manager account associated with the second ID (203). For example, the network component device may include a database storing one or more manager accounts. Each manager account may identify a client device (e.g., first ID), client application or client application user (e.g., visitor account information), that is known to be granted access to the network. Each manager account may further be assigned to a particular network component identified by the second ID. Therefore, the network control system may parse the database to identify a manager account assigned to the network component identified by the second ID, and determine whether a predetermined relationship is satisfied between the identified manager account and the visitor account information (203). The predetermined relationship may be set up to identify a “friend” relationship, a “relative” relationship, or other identifiable relationship between users that correspond to the visitor account information and the manager account information. The network control system may further determine a predetermined usage permission level assigned to the client device according to the client device's first ID, and grant the client device access to the network according to the assigned usage permission level (203).

By implementing the security protocol described by flow chart 200, the network component device, and by associated the network control system, may implement processes that, at least in part, provide selective access to the network based on a determination that a predetermined relationship is satisfied between the visitor account information received from the client device requesting network access and manager account information stored within the network control system. Based on a confirmation that the predetermined has been satisfied, the client device, as identified by the first ID, may be allowed access to the network. The access allowed to the client device may be in accordance to a predetermined usage permission level assigned to the client device's first ID, and/or as identified in the manager account.

The security protocol described by flow chart 200 allows the network control system to verify an identity of the client device, client application, and/or client application user, requesting access to network based on a relationship between the visitor account information (e.g., the visitor account information verifies the client device and/or client application user has successfully logged into the client application and/or client device) and the manager account (e.g., the manager account includes a list of client devices, client applications, and/or client application users that are known to have been granted access to the network) rather than verifying the identity of the client device, client application, or client application user, according to a password. Therefore, the solution described by flow chart 200 frees a user from being required to manually input a password to gain access to the network, which promotes the efficiency of saving the user operation time.

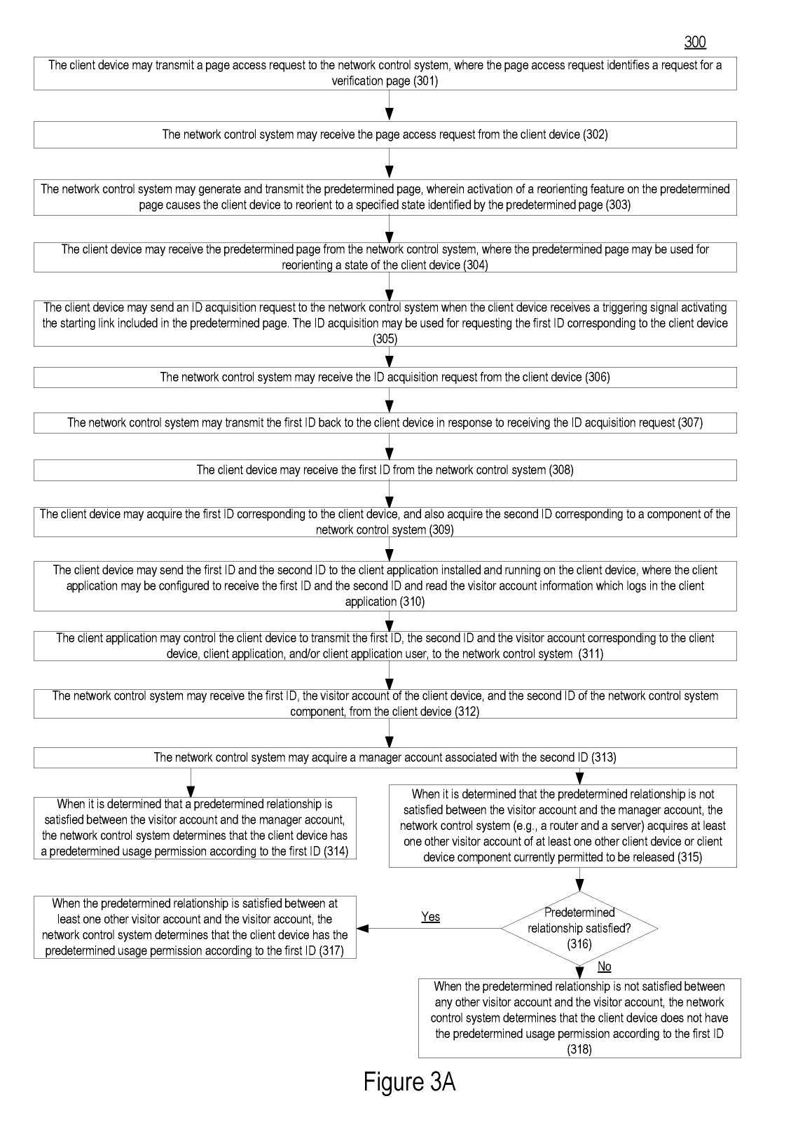

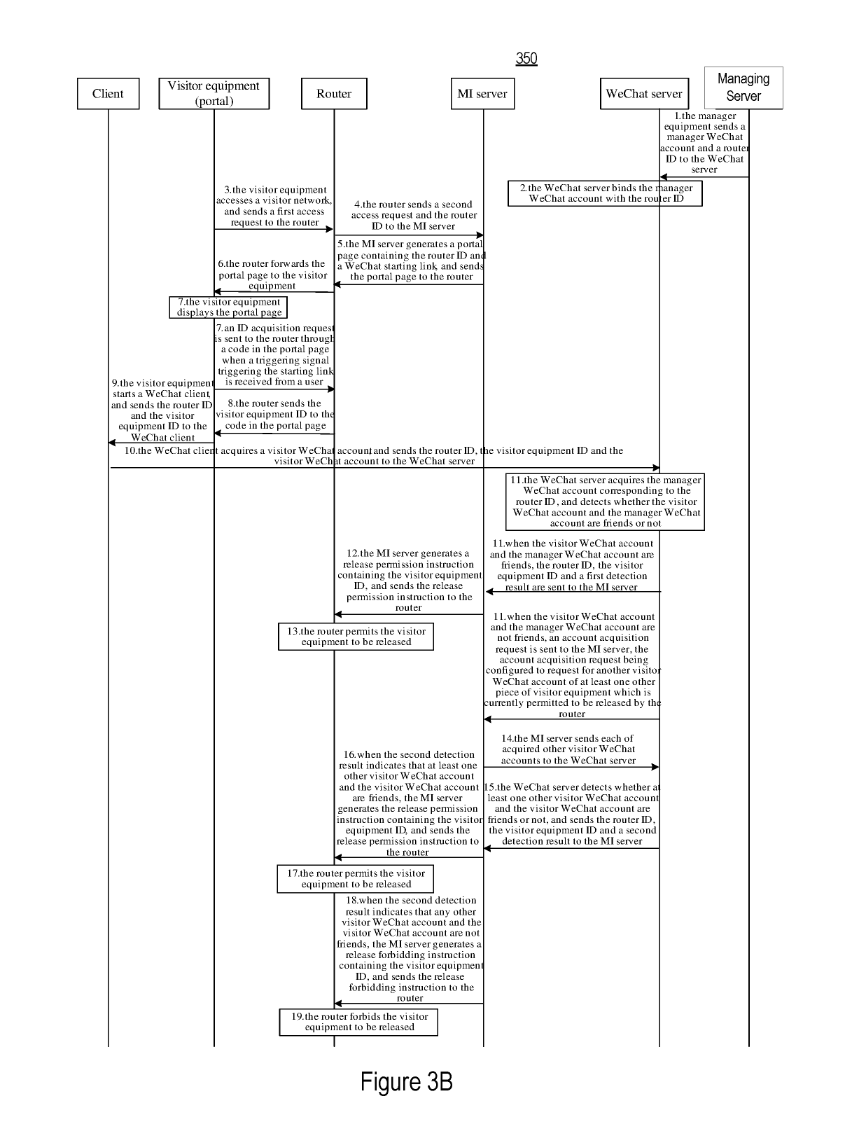

FIG. 3A shows a flow chart 300 of logic that a network control system may implement for determining whether to allow a requesting client device access to a corresponding network controlled by the network control system. According to the flow chart 300 shown in FIG. 3A, the network control system is described as implementing the security protocol such that when predetermined usage permission is assigned to the client device, the network control system will release the client device. Conversely, the network control system is described as implementing the security protocol such that when predetermined usage permission is not assigned to the client device, the network control system will be prevented from releasing the client device. During implementation of the processes described in flow chart 300, the predetermined usage permission is provided for exemplary purposes.

The client device may transmit a page access request to the network control system, where the page access request identifies a request for a verification page (301).

In the embodiments encompassed by the flow chart 300, electronic components of a host device may be referred to as manager components, while electronic components of the client device operating in communication with the host may be referred to as visitor components. Further, the network control system may be understood to include, at least, one of a router and a server.

The host may be configured to be a password-free visitor network according to a wireless network made accessible by the router, so that the visitor components may directly access the visitor network after finding the visitor network.

In describing the logic of step (301) in flow chart 300 in more detail, the visitor components (e.g., the client device, or components of the client device) may transmit a page access request to the router (e.g., the router may be a component of the network control system), where the page access request identifies a request to access a verification page upon finding the visitor network. The verification page may include specified tools used to verify whether the visitor components are permitted to access the visitor network or not. When a page returned to the visitor components according to the page access request is a predetermined verification page, this may verify that the network control system determined that the router permits the visitor components to be released, in which case the visitor components are permitted to access the visitor network (e.g., Internet). However, when the page returned according to the page access request is not the predetermined verification page, this may verify that the network control system determined that the router forbids the visitor components from being released, in which case the visitor components are not permitted access to the visitor network.

Referring back to the flow chart 300, the network control system may receive the page access request from the client device (302).

Here, when the network control system includes the router and the server, the router receives the page access request, determines whether the client device is included in a predetermined access list or not, returns the verification page to the visitor components when the visitor components are in the access list, otherwise, and the router reorients the visitor components to a predetermined page when the visitor components are not in the access list, wherein the access list is used to identify the visitor components that are permitted to be released by the router.

When the visitor components are reoriented to open the predetermined page, the router generates a predetermined access request for requesting the predetermined page, acquires the router's own second ID and transmits the predetermined access request and the second ID to the server. The second ID may be a Media Access Control (MAC) address, an ID, or the like for identifying the router, which is not limited in the embodiment. The router may be configured to be related to the server. For example, when the router is a MI router, the server may be a MI server.

Referring back to the flow chart 300, the network control system may generate and transmit the predetermined page, wherein activation of a reorienting feature on the predetermined page causes the client device to reorient to a specified state identified by the predetermined page (303). For example, the predetermined page may include the second ID corresponding to the network control system component, and a starting link for starting the client application on the client device.

When the network control system includes the router and the server, and the server receives a predetermined access request from the router, the server may be configured to determine the client application is to be started by the client device, or other visitor component. The network control system then generates the starting link used to start the client application, generates the predetermined page including the starting link and the second ID, and transmits the predetermined page to the router. The client application may be a social application, and the client application may be configured to provide a visitor account which logs in the client device for the server to determine a relationship between the client device, client application, and/or client application user, and the host according to the visitor account. For example, the client application may be WeChat, MiTalk, micro-blog and the like, which is not limited in the embodiment.

A client application type may be stored in the server, so that the server may generate a corresponding starting link according to the client application type of the client application. Alternatively, when may be multiple client application types stored in the server, such that the server may also generate a starting link corresponding to each client application type.

For example, when the client application is a WeChat client application, the starting link may be: one-key network accessing through WeChat. When the client application is a MiTalk client, the starting link may be: one-key network accessing through MiTalk. When the client is a blog client application, the starting link may be: one-key network accessing through a micro-blog.

The server may send the predetermined page to the router after generating the predetermined page. In response to receiving the predetermined page from the server, the router may transmit the predetermined page to the client device. The predetermined page may include the second ID and the starting link, where the starting link may be used to initiate a running of the client application.

Referring back to the flow chart 300, the client device may receive the predetermined page from the network control system, where the predetermined page may be used for reorienting a state of the client device (304).

According to some embodiments, the network control system transmitting the predetermined page to the client device may be the router.

Referring back to the flow chart 300, the client device may send an ID acquisition request to the network control system when the client device receives a triggering signal activating the starting link included in the predetermined page. The ID acquisition may be used for requesting the first ID corresponding to the client device (305).

After the client device receives the predetermined page, when the client device determines that the predetermined page is different from a verification page, then the client device may control a browser to display the predetermined page. The predetermined page may be a portal page.

When the client device receives the triggering signal generated by a user clicking a starting link included on the predetermined page, the client device may be caused to acquire its own first ID from the network control system, the first ID being sent to the network control system when the client device accesses the visitor network. Or, according to some embodiments, the client device may directly read the first ID from a local memory on the client device without acquiring the first ID from the network control system when the client device is able to directly read the first ID from itself.

Accordingly, instructional code may be included in a portal page, the instructional code may include instructions for sending an ID acquisition request to the network control system when the client device receives the triggering signal. Further, the network control system may transmit the first ID in accordance to the instructional code after receiving the ID acquisition request, where then the client device may then acquire the first ID. Here, the network control system component for implementing, at least part, the features in logical step (305) may be the router.

Referring back to the flow chart 300, the network control system may receive the ID acquisition request from the client device (306).

The network control system component for implementing, at least in part, the features in logical step (306) may be the router, such that the router may receive the ID acquisition request sent by the client device.

Referring back to the flow chart 300, the network control system may transmit the first ID back to the client device in response to receiving the ID acquisition request (307).

The network control system component for implementing, at least in part, the features in logical step (307) may be the router, such that the router may transmit the first ID to the client device.

Referring back to the flow chart 300, the client device may receive the first ID from the network control system (308).

The network control system component for implementing, at least in part, the features in logical step (308) may be the router, such that the client device receives the first ID from the router.

Referring back to the flow chart 300, the client device may acquire the first ID corresponding to the client device, and also acquire the second ID corresponding to a component of the network control system (309).

The client device may send the first ID and the second ID to the client application installed and running on the client device, where the client application may be configured to receive the first ID and the second ID and read the visitor account information which logs in the client application (310).

When the triggering signal is received, an execution sequence of the three steps of acquiring the first ID, acquiring the second ID and starting the client application is not limited in the embodiment.

When the visitor account has logged in the client application, the client application directly reads the visitor account. Alternatively, when there is no visitor account logged in the client application, the client may prompt the user to input the visitor account, and then the client application may read the visitor account.

For example, when the client application is WeChat, the visitor account may be a WeChat account. When the client is a MiTalk client application, the visitor account may be a MiTalk account. When the client is a micro-blog client application, the visitor account may be a micro-blog account.

Referring back to the flow chart 300, the client application may control the client device to transmit the first ID, the second ID and the visitor account corresponding to the client device, client application, and/or client application user, to the network control system (311).

The network control system component for implementing, at least in part, the features in logical step (311) may be a server, such that the client device transmits the first ID, the second ID and the visitor account to the server.

When the server is a cluster server, the client application may control the client device to directly transmit the first ID, the visitor account and the second ID to the cluster server. When the server is not a cluster server and the server corresponding to the client application is different from the server coupled with the router, the client application may transmit the first ID, the visitor account and the second ID to the server corresponding to the client application. For reference within this disclosure, the server corresponding to the client application may be referred to as a first server and the server coupled with the router may be referred to as a second server hereinafter.

For example, when the second server is a MI server and the client is a MiTalk client, the first ID, the MiTalk account and the second ID may be transmitted to the MI server, that is, the first server is the MI server. When the second server is a MI server and the client is a WeChat client, the first ID, the WeChat account and the second ID may be transmitted to a WeChat server, that is, the first server is the WeChat server.

Referring back to the flow chart 300, the network control system may receive the first ID, the visitor account of the client device, and the second ID of the network control system component, from the client device (312).

The network control system component for implementing, at least in part, the features in logical step (312) may be a server, such that the server receives the first ID, the visitor account of the client device, and the second ID from the client device.

Referring back to the flow chart 300, the network control system (e.g., a server) may acquire a manager account associated with the second ID (313).

A manager component may acquire the second ID of the server after accessing the router, and send the manager account which logs in the client application and the second ID to the server, and the server may associate the manager account with the second ID.

When receiving the second ID and the visitor account, the server acquires the manager account associated with the second ID, and detects whether a predetermined relationship is satisfied between the visitor account and the manager account or not. The predetermined relationship may be set up to identify a “friend” relationship, a “relative” relationship, or other identifiable relationship between users that correspond to the visitor account information and the manager account information. Here, the predetermined relationship may be preset and modified, and for example, the predetermined relationship refers to that the visitor account and the manager account share a friend's status, or the visitor account and the manager account belong to a same group, or the like, and there are no limits made in the embodiment.

Referring back to the flow chart 300, when it is determined that a predetermined relationship is satisfied between the visitor account and the manager account, the network control system (e.g., a router and a server) determines that the client device has a predetermined usage permission according to the first ID (314).

When the predetermined relationship is satisfied between the visitor account and the manager account, this indicates that a host user associated with the host device/manager component and a visitor user associated with the client device/client application know each other, or otherwise share a common link in terms of the common client application. It follows that the client device may be determined to have the predetermined usage permission. That is, the client device may be permitted to access the visitor network (e.g., Internet).

When the server is not a cluster server and the first server determines that the predetermined relationship is satisfied between the visitor account and the manager account, the result and the first ID are sent to the second server, and the second server generates a release permission instruction containing the first ID according to a querying result, and sends the release permission instruction to the router. When the server is a cluster server, the server generates the release permission instruction containing the first ID according to the querying result after obtaining the result, and sends the release permission instruction to the router, the router releases the client device according to the release permission instruction, the client device normally accesses the visitor network after being determined to be released by the network control system.

The first server may also acquire and send information such as a nickname and a head portrait of the visitor account to the second server, which is not limited in the embodiment.

The router may also add the first ID into an access list.

Referring back to the flow chart 300, when it is determined that the predetermined relationship is not satisfied between the visitor account and the manager account, the network control system (e.g., a router and a server) acquires at least one other visitor account of at least one other client device or client device component currently permitted to be released (315).

When there still exists other client devices accessing the router, and the router permits said other client devices to be released, the server may receive other visitor accounts of said other client devices before releasing said other client devices. In this way, the determination of whether the client device is permitted to be released or not may be made according to a relationship between the visitor account and said other visitor accounts corresponding to said other client devices.

When the server is not a cluster server, the first server may transmit an account acquisition request containing the second ID to the second server, and the second server may identify other visitor accounts corresponding to other client devices which are permitted to be released according to the second ID, and transmit each of the other visitor accounts to the first server. When the server is a cluster server, the server may directly identify said other visitor accounts of each of other client devices which are permitted to be released according to the second ID.

Referring back to the flow chart 300, the network control system may detect whether the predetermined relationship is satisfied between at least one other visitor account and the visitor account or not (316). When the predetermined relationship is satisfied between at least one other visitor account and the visitor account, the network control system determines that the client device has the predetermined usage permission according to the first ID (317). When the predetermined relationship is not satisfied between any other visitor account and the visitor account, the network control system determines that the client device does not have the predetermined usage permission according to the first ID (318).

The server detects whether the predetermined relationship is satisfied between a certain other visitor account and the visitor account or not, and when the predetermined relationship is satisfied between the certain other visitor account and the visitor account, it is indicated that the visitor and another visitor know each other, the client device may be permitted to access the visitor network (e.g., Internet) and logical step 317 may be executed. When the predetermined relationship is not satisfied between the certain other visitor account and the visitor account, whether the predetermined relationship is satisfied between next other visitor account and the visitor account or not is continuously detected. Here, the predetermined relationship may be the same as the predetermined relationship in logical step 314, or may also be different, which is not limited in the embodiment.

The network control system components for implementing, at least part, of the features described in logical steps (317) and (318) may include a router and a server.

When the predetermined relationship is not satisfied between any other visitor account and the manager account, it is indicated that the host and the visitor do not know each other, and the client device is determined not to have the predetermined using permission. That is, the client device is forbidden from accessing the visitor network (e.g., Internet).

When the server is not a cluster server and the first server determines that the predetermined relationship is not satisfied between the visitor account and the manager account, the result and the first ID are sent to the second server, and the second server generates a release forbidding instruction containing the first ID according to a querying result, and sends the release forbidding instruction to the router. When the server is a cluster server, the server generates a release forbidding instruction containing the first ID according to the querying result after obtaining the result, and sends the release forbidding instruction to the router.

The router may forbid the client device to be released according to the release forbidding instruction, and the client device may be determined to be forbidden from being released by the network control system, and is not permitted to access to the visitor network.

FIG. 3B shows a flow chart 350 of logic that a network control system may implement for determining whether to allow a requesting client device access to a corresponding network controlled by the network control system, according to a specific exemplary embodiment where the client application is a WeChat client, a first server is a WeChat server and a second server is a MI server. Further, the exemplary network control system may be configured to include one or more of a router, the MI server, the WeChat server, and a managing server. The client application is understood to be installed and running on the client device.

The manager server may transmit a manager WeChat account and a router ID to the WeChat server (1).

Based on receiving the manager WeChat account and a router ID, the WeChat server may associate the manager WeChat account with the router ID (2).

The client device may a visitor network controlled by the network control system, and upon accessing the visitor network, transmit a first access request to the router, the first access request being used to request to access a verification page (3).

The router may transmit a second access request and the router ID to the MI server (4).

The MI server may generate a portal page containing the router ID and a WeChat starting link, and transmit the portal page to the router (5).

The router may forward the portal page to the client device (6).

The client device may display the portal page, and transmit an ID acquisition request to the router (7). The client device may be activated to transmit the ID acquisition request based on a user selection of a code included in the portal page. The client device may be activated to transmit the ID acquisition, either in combination with the selection of the code or independent of the code, when receiving from a user input triggering signal that triggers a starting link included in the portal page. According to some embodiments, the starting link may be related to the code. The ID acquisition request may be referenced to request client device ID that identifies the client device.

The router may transmit the client device ID to the code in the portal page (8). The portal page may be a web-page for a web application. The web application may be used to provide individualized conglomeration of contents from various sources. The web application may provide user access to contents from a single login point. The web application may operate as a host at the presentation layer. The portal page may be configured according to a Portlet (pluggable user interface software components) protocol.

The client device initiates the WeChat client application to being running on the client device, if it was not previously running (9). The client device may further transmit the router ID and the client device ID to the WeChat client application (9). It follows that the WeChat client application has access to reference the received router ID and client device ID for subsequent analysis.

The WeChat client application acquires a visitor WeChat account, and controls transmission of the router ID, the client device ID and the visitor WeChat account to the WeChat server (10).

The WeChat server acquires the manager WeChat account corresponding to the router ID, and detects whether the visitor WeChat account and the manager WeChat account are friends or not, or, according to some embodiments, shares some other recognizable relationship (11). When the visitor WeChat account and the manager WeChat account are determined to be friends (or share some other recognizable relationship), the router ID, the client device ID and a first detection result are sent to the MI server and logical Step (12) is executed. Otherwise, when the visitor WeChat account and the manager WeChat account are determined not to be friends (or share some other recognizable relationship), an account acquisition request is transmitted to the MI server, the account acquisition request being used to request for at least one other visitor WeChat account corresponding to at least one other client device, client application, or client application user, which is currently permitted to be released by the router, and logical Step (14) is executed.

The MI server may generate a release permission instruction containing the client device ID, and transmit the release permission instruction to the router (12).

The router may permit the client device to be released, thus ending the network access security protocol.

The MI server may transmit each of the acquired other visitor WeChat accounts to the WeChat server (14).

The WeChat server may detect whether at least one other visitor WeChat account and the visitor WeChat account are friends or not, or, according to some embodiments, shares some other recognizable relationship (15). The WeChat server may also transmit the router ID, the client device ID and a second detection result to the MI server (15).

When the second detection result indicates that at least one other visitor WeChat account and the visitor WeChat account are friends, or shares some other recognizable relationship, the MI server may generate a release permission instruction containing the client device ID, and sends the release permission instruction to the router (16).

The router may permit the client device to be released, thus ending the network access security protocol (17).

When the second detection result indicates that any other visitor WeChat account and the visitor WeChat account are not friends, or shares some other recognizable relationship, the MI server generates a release forbidding instruction containing the client device ID, and sends the release forbidding instruction to the router (18).

The router may forbid the client device from being released, thus ending the network access security protocol (19).

From the above description of flow chart 350, the first ID and the visitor account of the client device and the second ID of the network control system component are received based on a control signals implemented by the client application running on the client device. Further, the manager account associated with the second ID may be acquired, and when it is determined that a predetermined relationship is satisfied between the visitor account and the manager account, the client device may be granted a predetermined usage permission according to the client device's first ID. According to this solution, the network control system may verify an identity of a client device, client application, or client application user (e.g., a visitor), according to the relationship between the visitor account which logs in the client application and the manager account. This offers efficiencies over requiring the additional steps of verifying the identity of the visitor according to a password. Therefore, the problem that the client device is required to input the password to be granted the predetermined usage permission to access the visitor network is solved, and an effect of saving operation time for the visitor to input the password is achieved.

In addition, the predetermined page used for reorientation is generated and sent to the client device through one or more network components of the network control system. The predetermined page may include the second ID and a starting link, where activation of the starting link may cause the client application to initiate running on the client device. By utilizing the starting link, a visitor may acquire the predetermined usage permission through a single selection action by activating the starting link. In this way, operation of acquiring the predetermined usage permission is simplified, and acquisition efficiency for the usage permission is improved.

Moreover, when the predetermined relationship is not satisfied between the visitor account and the manager account, whether the predetermined relationship is satisfied between the visitor account and other visitor accounts of other client devices, or when other visitor accounts or other client devices are not detected, so that the network control system may further verify the identity of the visitor according to said other visitor accounts. By doing so, the network control system operates the network access security protocol to avoid complexity in the operation of acquiring the predetermined usage permission due to the fact that it is needed to make the visitor account and the manager account consistent with the predetermined relationship when the predetermined relationship is not satisfied between the visitor account and the manager account, and achieving an effect of simplifying a verification for granting the client device access to the visitor network.

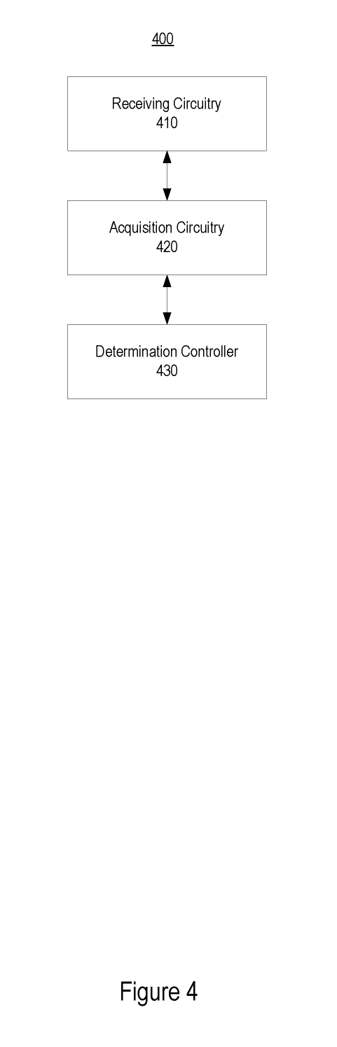

FIG. 4 is a diagram showing structure 400 for implementing a logic that an exemplary network control system may implement. The structure 400 may include software, hardware, circuitry, or any combination thereof, for implementing the described features of structure 400. The structure 400 may be configured to implement any one or more of the processes described with reference to flow chart 100, flow chart 200, flow chart 300, flow chart 350, or other processes described herein. The structure 400 includes: a receiving circuitry 410, an acquisition circuitry 420 and a determination controller 430. With respect to the description of structure 400, reference to a network control system may be a reference to a network component device included within the network control system.

The receiving circuitry 410 is configured to receive a first ID and a visitor account corresponding to a visitor (e.g., client device, client application installed on running on the client device, or a client application user), and also receive a second ID corresponding to a network component (e.g., a router or server within the network control system) included in a network control system, from the client device, wherein a client application installed and running on the client device may control the client device to transmit the first ID, visitor account, and the second ID to the receiving circuitry 410.

The acquisition circuitry 420 is configured to acquire a manager account associated with the second ID.

The determination controller 430 is configured to, when it is determined that a predetermined relationship is satisfied between the visitor account and the manager account, determine that the client device is granted a predetermined usage permission according to the first ID for accessing a visitor network controlled by the network control system.

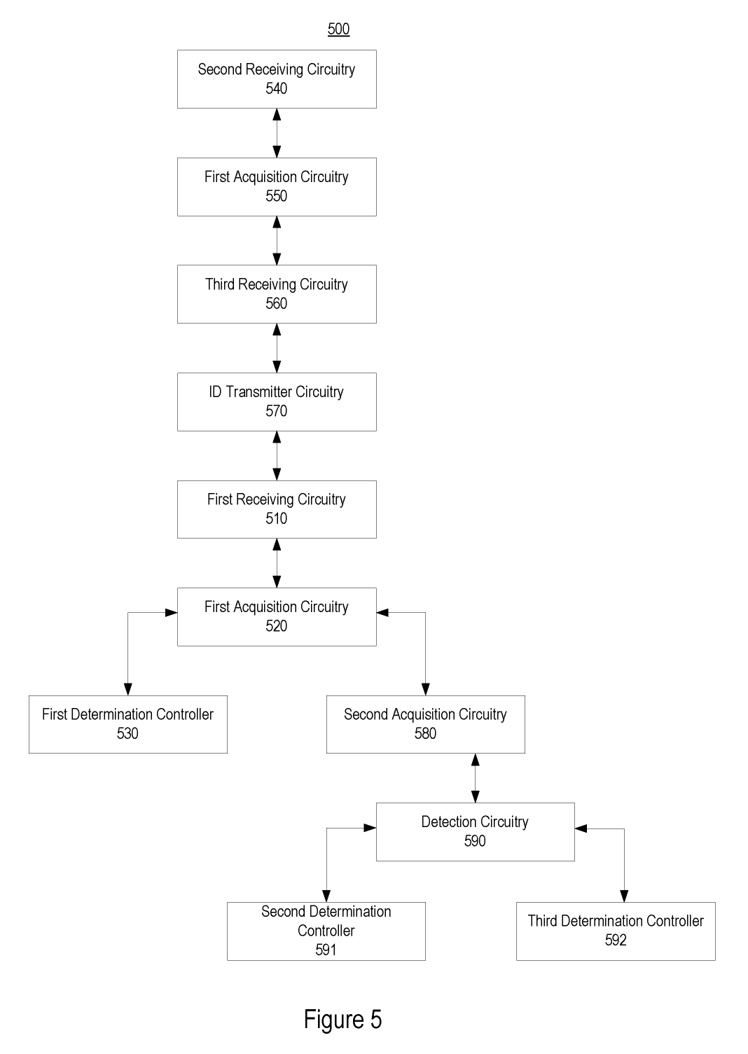

FIG. 5 is a diagram showing structure 500 for implementing a logic that an exemplary network control system may implement. The structure 500 may include software, hardware, circuitry, or any combination thereof, for implementing the described features of structure 500. The structure 500 may be configured to implement any one or more of the processes described with reference to flow chart 100, flow chart 200, flow chart 300, flow chart 350, or other processes described herein. With respect to the description of structure 500, reference to a network control system may be a reference to a network component included within the network control system.

A first receiving circuitry 510 is configured to receive a first ID and a visitor account corresponding to a visitor (e.g., client device, client application installed on running on the client device, or a client application user) and a second ID corresponding to a network component device (e.g., a router or server within network control system), wherein a client application installed and running on the client device controls the client device to transmit the first ID, visitor account, and the second ID to the first receiving circuitry 510

A first acquisition circuitry 520 is configured to acquire a manager account associated with the second ID.

A first determination controller 530 is configured to, when it is determined that a predetermined relationship is satisfied between the visitor account and the manager account, determine that the client device is granted a predetermined usage permission according to the first ID for accessing a visitor network controlled by the network control system.

According to some embodiments, the structure 500 may further include a second receiving circuitry 540 and a page generation circuitry 550, as illustrated in FIG. 5.

The second receiving circuitry 540 is configured to receive a page access request from the client device, the page access request being used for allowing the client device to request access to a verification page.

The page generation circuitry 550 is configured to generate and transmit a predetermined page for reorientation to the client device, the predetermined page including the second ID and a starting link. The starting link, when activated on the client device, being configured to initiate a running of the client application on the client device.

According to some embodiments, the structure 500 may further include a third receiving circuitry 560 and an ID transmitter circuitry 570, as illustrated in FIG. 5.

The third receiving circuitry 560 receives an ID acquisition request from the client device, the ID acquisition request being transmitted from the client device when the client device detects a triggering signal based on an activation of the starting link being presented on the client device. The ID acquisition request may be referenced by the third receiving circuitry 560, or another network component of the structure 500, to request the client device for the first ID.

The ID transmitter circuitry 570 is configured to transmit the first ID to the client device, the client device being configured to transmit the first ID and the second ID to the client application running on the client device, and the client application being configured to receive the first ID and the second ID and read the visitor account which logs in the client application.

According to some embodiments, the structure 500 may further include a second acquisition circuitry 580, a detection circuitry 590 and a second determination controller 591, as illustrated in FIG. 5.

The second acquisition circuitry 580 is configured to, when it is determined that the predetermined relationship is not satisfied between the visitor account and the manager account, acquire at least one other visitor account of at least one other client device currently granted the predetermined usage permission for accessing the visitor network.

The detection circuitry 590 is configured to detect whether the predetermined relationship is satisfied between at least one other client device acquired by the second acquisition circuitry 580 and the visitor account or not.

The second determination controller 591 is further configured to, when a detection result of the detection circuitry 590 indicates that the predetermined relationship is satisfied between at least one other visitor account and the visitor account of the client device, determine that the client device is granted the predetermined usage permission according to the first ID for accessing the visitor network.

According to some embodiments, the structure 500 may further include a third determination controller 592, as illustrated in FIG. 5.

The third determination controller 592 is configured to, when the detection result of the detection circuitry 590 indicates that the predetermined relationship is not satisfied between any other visitor account and the visitor account of the client device, determine that the client device is not granted the predetermined usage permission according to the first ID for accessing the visitor network.

In addition, the predetermined page for reorientation is generated and transmitted to the client device through the structure 500, the predetermined page including the second ID and a starting link. The starting link being used to initiate running of the client application on the client device, so that a visitor may acquire the predetermined usage permission by one step by triggering the starting link, operation of acquiring the predetermined usage permission is simplified, and acquisition efficiency for the usage permission is improved.

Moreover, when the predetermined relationship is not satisfied between the visitor account and the manager account, structure 500 proceeds to determine whether the predetermined relationship is satisfied between the visitor account and other visitor accounts corresponding to other client devices, or whether other visitor accounts are not detected, so that the network control system 500 may further verify the identity of the visitor according to said other visitor account, the problem of complexity in the operation of acquiring the predetermined usage permission due to the fact that it is needed to make the visitor account and the manager account consistent with the predetermined relationship when the predetermined relationship is not satisfied between the visitor account and the manager account is solved, and an effect of simplifying a verification for granting access to the visitor network is achieved.

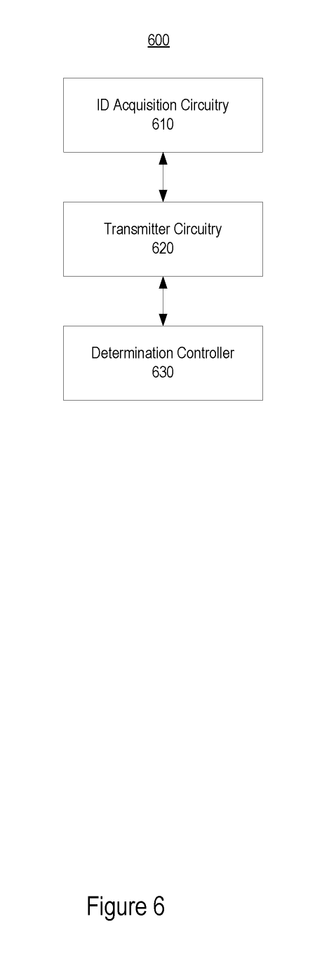

FIG. 6 is a diagram of an exemplary structure 600 for implementing a logic that an exemplary device (e.g., network component device included in a network control system) may implement. The structure 600 may include software, hardware, circuitry, or any combination thereof, for implementing the described features of structure 600. The structure 600 may be configured to communicate with a client device, where the structure 600 includes an ID acquisition circuitry 610, a transmitter circuitry 620 and a determination controller 630. The structure 600 may be configured to implement any one or more of the processes described with reference to flow chart 100, flow chart 200, flow chart 300, flow chart 350, or other processes described herein.

The ID acquisition circuitry 610 is configured to acquire a first ID of the client device and a second ID corresponding to a network component (e.g., a router or server included in the network control system 600) of a network control system. With respect to the description of structure 600, reference to the network control system may be a reference to a network component included within the network control system.

The transmitter circuitry 620 is configured to transmit the first ID and the second ID and a visitor account corresponding to a visitor (e.g., client device, client application installed on running on the client device, or a client application user) to a network component of the structure 600 (e.g., a server within the network control system).

The determination controller 630 is configured to determine that the network control system has access to a predetermined usage permission, the network control system being configured to acquire a manager account associated with the second ID and determine that the client device is granted the predetermined usage permission according to the first ID for accessing a visitor network controlled by the network control system when it is determined that a predetermined relationship is satisfied between the visitor account and the manager account.

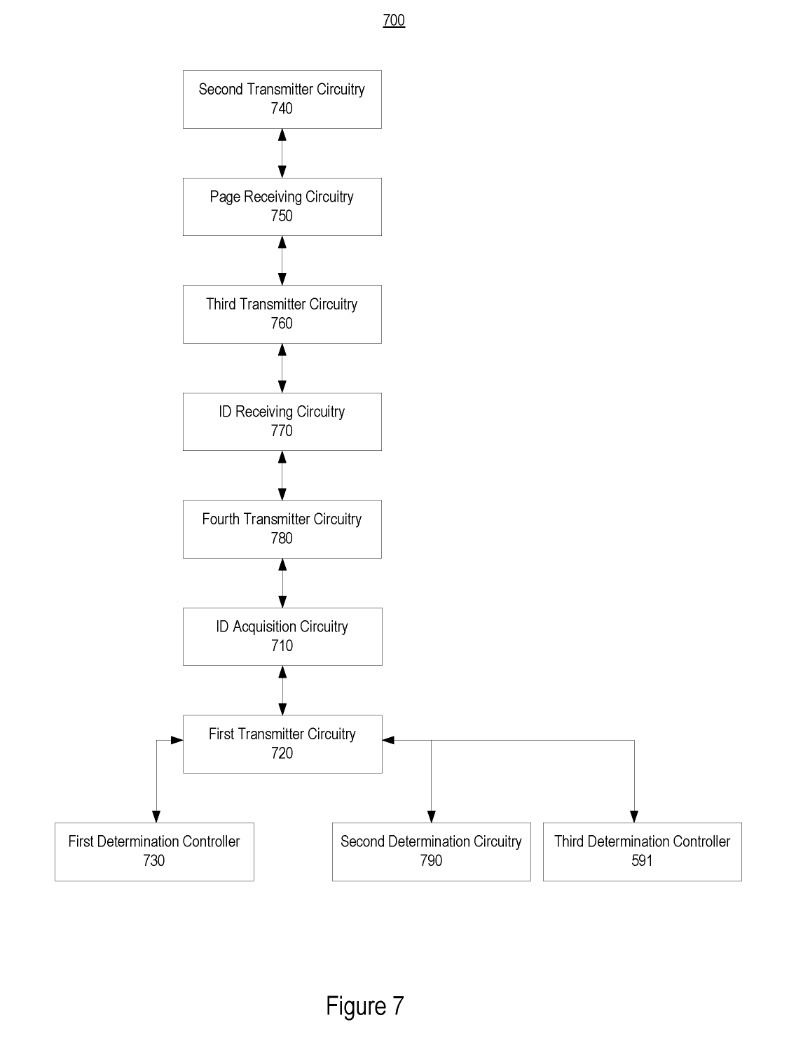

FIG. 7 is a diagram showing structure 700 for implementing a logic that an exemplary device may implement. The structure 700 may include software, hardware, circuitry, or any combination thereof, for implementing the described features of structure 700. The structure 700 may be configured to implement any one or more of the processes described with reference to flow chart 100, flow chart 200, flow chart 300, flow chart 350, or other processes described herein. With respect to the description of network control system 700, reference to a network control system may be a reference to a network component included within the network control system.

An ID acquisition circuitry 710 is configured to acquire a first ID identifying a client device and a second ID corresponding to a network component device included in the network control system (e.g., a router or server within network control system).

A first transmitter circuitry 720 is configured to transmit the first ID and the second ID and a visitor account corresponding to a visitor (e.g., client device, client application installed on running on the client device, or a client application user) to a network component included in the network control system (e.g., a router or server of the network control system).

A first determination controller 730 is configured to determine that the network control system stores a predetermined usage permission, the network control system being configured to acquire a manager account associated with the second ID and determine that the client device is granted the predetermined usage permission according to the first ID for accessing a visitor network controlled by the network control system when it is determined that a predetermined relationship is satisfied between the visitor account and the manager account.

According to some embodiments, the structure 700 may further include a second transmitter circuitry 740 and a page receiving circuitry 750.

The second transmitter circuitry 740 is configured to transmit a page access request to the network control system, the page access request being used for requesting access to a verification page.

The page receiving circuitry 750 may be configured to receive a predetermined page for reorientation of the client device from the network control system, the predetermined page including the second ID and a starting link. The starting link may be presented on the client device such that activation of the starting link may initiate a client application installed on the client device to begin running.

According to some embodiments, the structure 700 may further include a third transmitter circuitry 760, an ID receiving circuitry 770 and a fourth transmitter circuitry 780.

The third transmitter circuitry 760 is configured to, when a triggering signal indicating an activation of the starting link is received from the client device, transmit an ID acquisition request to the network control system.

The ID receiving circuitry 770 is configured to receive the first ID from the network control system.

The fourth transmitter circuitry 780 is configured to transmit the first ID and second ID to the client application running on the client device, the client application being configured to receive the first ID and the second ID and read the visitor account which logs in the client application.

According to some embodiments, the structure 700 may further include a second determination controller 790.

The second determination controller 790 is configured to determine that the network control system has the predetermined usage permission, the network control system being configured to acquire at least one other visitor account of at least one other client device currently granted the predetermined usage permission for accessing a visitor network controlled by the network control system when it is determined that the predetermined relationship is not satisfied between the visitor account and the manager account. The network control system may further be configured to determine that the client device is granted the predetermined usage permission according to the first ID when it is determined that the predetermined relationship is satisfied between at least one other visitor account and the visitor account corresponding to the visitor.

According to some embodiments, the structure 700 may further include a third determination controller 791.

The third determination controller 791 is configured to determine that the network control system does not have the predetermined usage permission, wherein the network control system is configured to determine that the client device is not granted the predetermined usage permission according to the first ID when it is determined that the predetermined relationship is not satisfied between any other visitor accounts and the visitor account corresponding to the visitor.

In addition, the predetermined page used for reorientation is generated and transmitted to the client device through the network control system, the predetermined page including the second ID and the starting link. The starting link may be used to start the client application on the client device, so that a visitor may acquire the predetermined usage permission by one step of triggering the starting link. Thus operation of acquiring the predetermined usage permission is simplified, and acquisition efficiency for the usage permission is improved.

Moreover, when the predetermined relationship is not satisfied between the visitor account and the manager account, the network control system proceeds to determine whether the predetermined relationship is satisfied between the visitor account and other visitor accounts of other client devices, or whether other visitor accounts are not detected, so that the network control system may further verify the identity of the visitor according to said other visitor accounts, the problem of complexity in the operation of acquiring the predetermined usage permission due to the fact that it is needed to make the visitor account and the manager account consistent with the predetermined relationship when the predetermined relationship is not satisfied between the visitor account and the manager account is solved, and an effect of simplifying a verification for granting access to the visitor network is achieved.

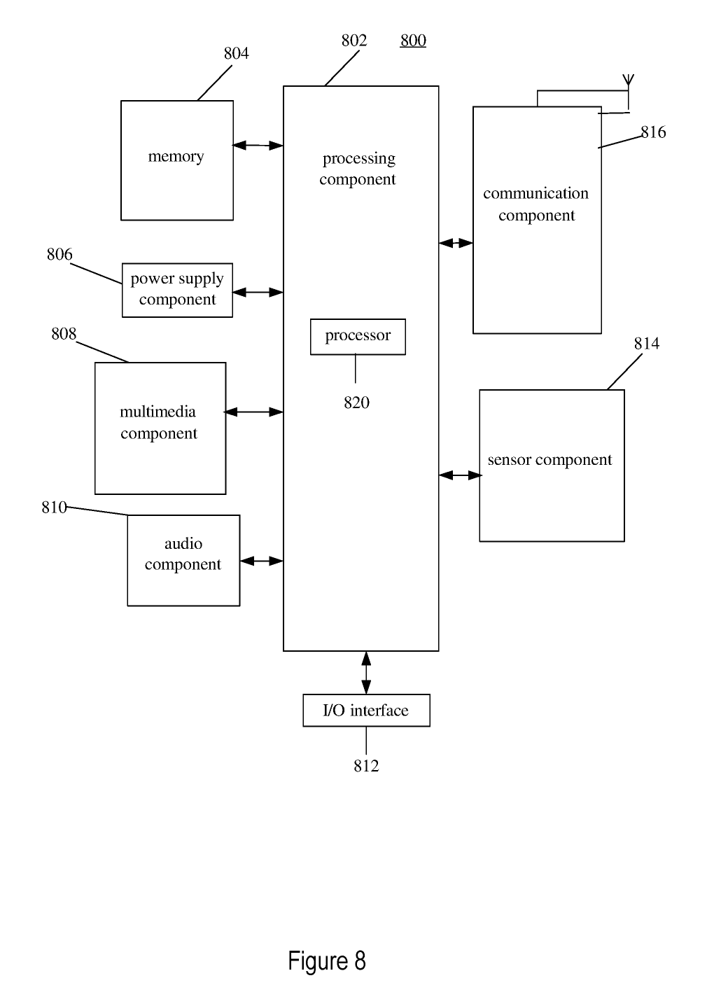

FIG. 8 is a block diagram of a network component device 800 that may be included in a network control system according to this disclosure. For example, the network component device 800 may be a mobile phone, a computer, a digital broadcast terminal, a messaging device, a gaming console, a tablet device, a medical device, fitness equipment, a personal digital assistant, a router, a server, or the like.

Referring to FIG. 8, the network component device 800 may include one or more of the following: a processing component 802, a memory 804, a power component 806, a multimedia component 808, an audio component 810, an Input/Output (I/O) interface 812, a sensor component 814, and a communication component 816.

The processing component 802 control operations of the network component device 800, such as the operations associated with display, telephone calls, data communications, camera operations, recording operations, or other operation described herein. The processing component 802 may include one or more processors 820 to execute instructions to perform all or part of the processes attributable to a network control system described herein, and in particular to a circuitry or controller described herein. Moreover, the processing component 802 may include one or more circuitry which facilitate interaction between the processing component 802 and the other components. For instance, the processing component 802 may include a multimedia circuitry to facilitate interaction between the multimedia component 808 and the processing component 802.

The memory 804 is configured to store various types of data to support the operation of the network component device 800. Examples of such data include instructions for any applications or methods operated on the network component device 800, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 provides power for various components of the network component device 800. The power component 806 may include a power management system, one or more power supplies, and other components associated with the generation, management and distribution of power for the network component device 800.

The multimedia component 808 includes a display providing an output interface between the network component device 800 and a user. For example, the display may display a page or link, as described herein, for presenting the page or link to the user for activation. In some embodiments, the display may include a display such as a Liquid Crystal Display (LCD) and/or a Touch Panel (TP). If the display includes the TP, the display may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 808 includes a front camera and/or a rear camera. The front camera and/or the rear camera may receive external multimedia data when the network component device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a microphone (MIC), and the MIC is configured to receive an external audio signal when the network component device 800 is in the operation mode, such as a call mode, a recording mode and a voice recognition mode. The received audio signal may be further stored in the memory 804 or sent through the communication component 816. In some embodiments, the audio component 810 further includes a speaker configured to output the audio signal.

The I/O interface 812 provides an interface between the processing component 802 and peripheral interface modules, such as a keyboard, a click wheel, a button and the like. The button may include, but not limited to: a home button, a volume button, a starting button and a locking button.

The sensor component 814 includes one or more sensors configured to provide status assessment in various aspects of the network component device 800. For instance, the sensor component 814 may detect an open/closed status of the network component device 800 and relative positioning of components, such as the display and the keypad, of the network component device 800, and the sensor component 814 may further detect a change in position of the network component device 800 or a component of the network component device 800, a presence or absence of contact between the user and the network component device 800, an orientation or an acceleration/deceleration of the network component device 800 and a change in temperature of the network component device 800. The sensor component 814 may include a proximity sensor configured to detect presence of an nearby object without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the network component device 800 and another device, such as another network component device included in a network control system. The network component device 800 may access a wireless network based on a communication standard, such as WiFi, 2nd-Generation (2G) or 3rd-Generation (3G), or a combination thereof. In an exemplary embodiment, the communication component 816 receives a broadcast signal or broadcast associated information from an external broadcast management system through a broadcast channel. In an exemplary embodiment, the communication component 816 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BT technology and another technology.

In an exemplary embodiment, the network component device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned methods.

In an exemplary embodiment, there is also provided a non-transitory computer-readable storage medium storing instructions, such as the memory 804 including an instruction, and the instruction may be executed by the processor 820 of the network component device 800 to implement any of the processes, methods, or other features of the network control systems described herein. For example, the non-transitory computer-readable storage medium may be a ROM, a Random Access Memory (RAM), a Compact Disc Read-Only Memory (CD-ROM), a magnetic tape, a floppy disc, an optical data storage device and the like.

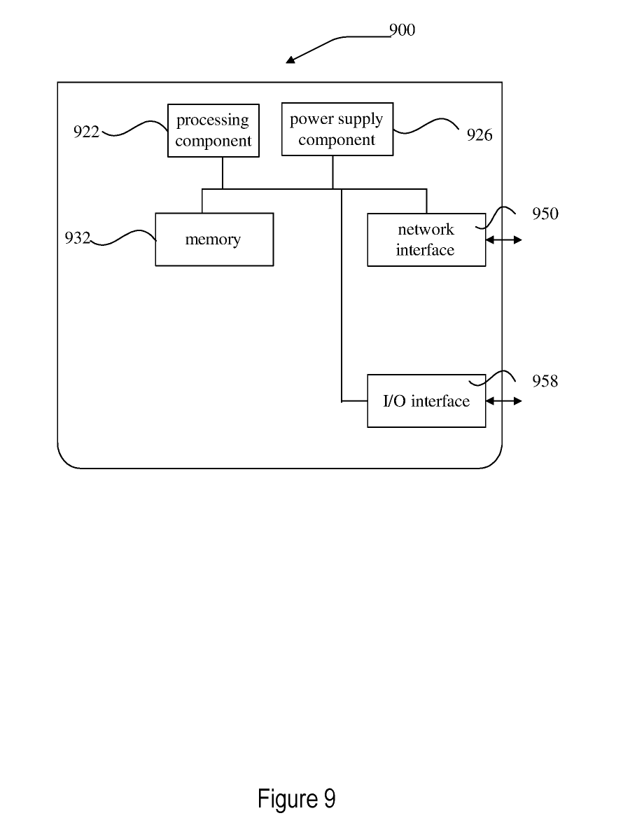

FIG. 9 is a block diagram of a network component device 900 that may be included in a network control system according to this disclosure. For example, the network component device 900 may be a server. Referring to FIG. 9, the network component device 900 includes a processing component 922 which further includes one or more processors, and a memory resource represented by a memory 932 configured to store instructions such as application programs executable for the processing component 922. The application programs stored in the memory 932 may include instructions for implementing processes attributable to a network control system described herein, and in particular to a circuitry or controller described herein. In addition, the processing component 922 is configured to execute the instructions to execute any one or more of the processes described in flow chart 100, flow chart 200, flow chart 300, flow chart 350, or other features of the network control systems.

The network component device 900 may further include a power component 926 configured to execute power management of the network component device 900, a wired or wireless network interface 950 configured to connect the network component device 900 to a network, and an I/O interface 958. The network component device 900 may be operated on the basis of an operating system stored in the memory 932, such as Windows Server™, Mac OS X™, Unix™, Linux™ or FreeBSD™.

Other embodiments of the present disclosure will be apparent to those skilled in the art from consideration of the specification and practice of the embodiments of the present disclosure disclosed here. This application is intended to cover any variations, uses, or adaptations of the embodiments of the present disclosure following the general principles thereof and including such departures from the embodiments of the present disclosure as come within known or customary practice in the art. It is intended that the specification and examples be considered as exemplary only, with a true scope and spirit of the embodiments of the present disclosure being indicated by the following claims.

It will be appreciated that the embodiments of the present disclosure is not limited to the exact construction that has been described above and illustrated in the accompanying drawings, and that various modifications and changes may be made without departing from the scope thereof. It is intended that the scope of the embodiments of the present disclosure only be limited by the appended claims.

### INDUSTRY APPLICABILITY

According to the technical solutions provided by the embodiments of the present disclosure, a first ID of a client device, a visitor account, and a second ID of a network component are received due to a client application running on the client device; a manager account associated with the second ID is acquired; and when it is determined that a predetermined relationship is satisfied between the visitor account and the manager account, the client device is determined to have a predetermined usage permission according to the first ID for accessing a visitor network controlled by a network control system, so that the network control system may verify an identity of a visitor according to the relationship between the visitor account which logs in the client application and the manager account rather than verifying the identity of the visitor according to a password. This way the problem that the client device is required to provide a password to be granted the predetermined usage permission is solved, and an effect of saving operation the visitor from having to input the password is achieved.

In addition, a predetermined page used for reorientation is generated and sent to the client device by the network control system, the predetermined page including the second ID and a starting link. The predetermined page may be presented on the client device such that a user may activate (e.g., select) the starting link to start running of the client application on the client device. This way, the user may acquire the predetermined usage permission by one key step of triggering an activation of the starting link, and the operation of acquiring the predetermined usage permission is simplified, and acquisition efficiency for the usage permission is improved.

Moreover, when the predetermined relationship is not satisfied between the visitor account and the manager account, whether the preset relationship is satisfied between the visitor account and other visitor accounts of other client devices or not is detected, so that the network control system may further verify the identity of the visitor according to said other visitor accounts, thereby avoiding the complexity in the operation of acquiring the predetermined usage permission due to the fact that it is needed to make the visitor account and the manager account meet the predetermined relationship when the predetermined relationship is not satisfied between the visitor account and the manager account, and achieving an effect of simplifying a verification flow.

What is claimed is:

1. A method for operating a network control system, the method comprising:
receiving a first Identifier (first ID) identifying a client device in communication with a communication network, account information corresponding to a client application, and a second Identifier (second ID) identifying the network control system;
acquiring a manager account information associated with the second ID;
comparing the account information to the manager account information;
determining whether a predetermined relationship between the account information and the manager account information is satisfied based on the comparison; and
when the predetermined relationship is determined to be satisfied between the account information and the manager account information, granting the client device a predetermined usage permission for accessing the communication network.

2. The method of claim 1, further comprising:
receiving a page access request from the client device, the page access request including instructions for requesting access to a verification page;
generating a verification page in response to receiving the page access request; and
transmitting the verification page to the client device, the verification page including the second ID and a starting link, wherein activation of the starting link by the client device initiates the client application to run on the client device.

3. The method of claim 2, further comprising:
receiving an ID acquisition request from the client device, the ID acquisition request being transmitted by the client device based on an activation of the starting link presented on the client device, and the ID acquisition request including a request for the first ID; and
transmitting the first ID to the client device, wherein the client device is configured to provide the first ID and the second ID to the client application for the client application to read the account information which logs in the client application.

4. The method of claim 1, further comprising:
when it is determined that the predetermined relationship is not satisfied between the account information and the manager account information, acquiring at least one other account information of at least one other client device granted the predetermined usage permission for accessing the communication network;
determining whether the predetermined relationship is satisfied between the at least one other account information and the account information; and
when the predetermined relationship is satisfied between the at least one other account information and the account information, granting the client device the predetermined usage permission.

5. The method of claim 4, further comprising:
when the predetermined relationship is not satisfied between any other detectable account information and the account information, determining that the client device is not granted the predetermined usage permission.

6. A method for operating a network control system, the method comprising:
acquiring a first Identifier (first ID) of identifying a client device in communication with a communication network and a second Identifier (second ID) identifying a network component included in the network control system;
transmitting the first ID, the second ID, and an account information corresponding to a client application; and
determining that the network control system has access to a database storing predetermined usage permissions, wherein the network component is configured to acquire a manager account information associated with the second ID and determine that the client device is granted a predetermined usage permission to the communication network when a predetermined relationship is satisfied between the account information and the manager account information.

7. The method of claim 6, further comprising:
transmitting a page access request to the network component, the page access request including instructions for requesting access to a verification page; and
receiving the verification page from the network component, the verification page including the second ID and a starting link, wherein activation of the starting link by the client device initiates the client application to run on the client device.

8. The method of claim 7, further comprising:
when a triggering signal indicating activation of the starting link is received, transmitting an ID acquisition request to the network component;
receiving the first ID from the network component; and
transmitting the first ID and the second ID to the client device, wherein the client device is configured to receive the first ID and the second ID and provide the first ID and the second ID to the client application to read the account information which logs in the client application.

9. The method of claim 6, further comprising:
when the network control system is determined to have access to the predetermined usage permission, acquiring at least one other account information corresponding to at least one other client device granted the predetermined usage permission when it is determined that the predetermined relationship is not satisfied between the account information and the manager account information; and
determining that the client device is granted the predetermined usage permission when it is determined that the predetermined relationship is satisfied between the at least one other account information and the account information.

10. The method of claim 9, further comprising:
when the network control system is determined not to have access to the predetermined usage permission, determining the client device is not granted the predetermined usage permission when the predetermined relationship is not satisfied between any other detectable account information and the account information.

11. A network control system comprising:
an interface configured to receive a first Identifier (first ID) identifying a client device in communication with a communication network, an account information corresponding to a client application, and a second Identifier (second ID) identifying the network control system;
a database configured to store a manager account information;
a processor; and
a memory configured to store instructions executable by the processor to:
parse the manager account information stored on the database;
acquire a manager account information associated with the second ID based on the parsing;
compare the account information to the manager account information;
determine whether a predetermined relationship between the account information and the manager account information is satisfied based on the comparison; and
when it is determined that the predetermined relationship is satisfied between the account information and the manager account information, granting the client device a predetermined usage permission for accessing the communication network.

12. The network control system of claim 11, wherein the processor is further configured to:
receive a page access request from the client device, the page access request including instructions for requesting access to a verification page; and
generate a verification page in response to receiving the page access request; and
transmit the verification page used to the client device, the verification page including the second ID and a starting link, wherein activation of the starting link by the client device initiates the client application to run on the client device.

13. The network control system of claim 12, wherein the processor is further configured to:
receive an ID acquisition request from the client device, the ID acquisition request being transmitted by the client device based on an activation of the starting link presented on the client device, and the ID acquisition request including a request for the first ID; and
transmitting the first ID to the client device, wherein the client device is configured to provide the first ID and the second ID to the client application for the client application to read the account information which logs in the client application.

14. The network control system of claim 11, wherein the processor is further configured to:
when it is determined that the predetermined relationship is not satisfied between the account information and the manager account information, acquire at least one other account information of at least one other client device granted the predetermined usage permission for accessing the communication network;
determining whether the predetermined relationship is satisfied between the at least one other account information and the account information; and
when the predetermined relationship is satisfied between the at least one other account information and the account information, granting the client device the predetermined usage permission.

15. The device according to claim 14, wherein the processor is further configured to:
when the predetermined relationship is not satisfied between any other detectable account information and the account information, determine that the client device is not granted the predetermined usage permission.

16. A network control system comprising:
a processor; and
a memory configured to store instructions executable by the processor to:
acquire a first Identifier (first ID) identifying a client device in communication with a communication network and a second Identifier (second ID) identifying a network component included in the network control system;
transmit the first ID, the second ID, and an account information corresponding to client application; and
determine that the network control system has access to a database storing predetermined usage permissions, wherein the network component is configured to acquire a manager account information associated with the second ID and determine that the client device is granted a predetermined usage permission when a predetermined relationship is satisfied between the account information and the manager account information.

17. The network control system of claim 16, wherein the processor is further configured to:
transmit a page access request to the network component, the page access request including instructions for requesting access to a verification page; and
receive the verification page from the network component, the verification page including the second ID and a starting link, wherein activation of the starting link by the client device initiates the client application to run on the client device.

18. The network control system of claim 17, wherein the processor is further configured to:
when a triggering indicating activation of the starting link is received, transmitting an ID acquisition request to the network component;
receive the first ID from the network component; and
transmit the first ID and the second ID to the client device, wherein the client device is configured to receive the first ID and the second ID and provide the first ID and the second ID to the client application to read the account information which logs in the client application.

19. The network control system of claim 16, wherein the processor is further configured to:
when the network control system is determined to have access to the predetermined usage permission, acquire at least one other account information corresponding to at least one other client device granted the predetermined usage permission when it is determined that the predetermined relationship is not satisfied between the account information and the manager account information; and
determine that the client device is granted the predetermined usage permission when it is determined that the predetermined relationship is satisfied between the at least one other account information and the visitor account information.

20. The network control system of claim 19, wherein the processor is further configured to:
when the network control system is determined not to have access to the predetermined usage permission, determine that the client device is not granted the predetermined usage permission when the predetermined relationship is not satisfied between any other detectable account information and the visitor account information.
